(19) United States
(12) Patent Application Publication
(10) Pub. No.: US 2014/0156240 A1
(43) Pub. Date: Jun. 5, 2014

(54) Simulation Method And Apparatus Of The Effects Of A Welding Process

(71) Applicant: Leardo Ruggenenti, Visano (IT)

(72) Inventor: Leardo Ruggenenti, Visano (IT)

(21) Appl. No.: 13/691,875

(22) Filed: Dec. 3, 2012

(51) Int. Cl. G06F 17/50

(52) U.S. Cl. CPC G06F 17/5009
USPC 703/6

(57) ABSTRACT

The present invention relates to a simulation method and apparatus of the deformations and inner tensions generated by a welding process of metal parts suitable for composing a metal structure. Methods are described for simulation using a simulation programme to calculate the deformations and tensions generated by the welding of metal parts suitable for composing a metal structure.

The present invention relates to a simulation method and apparatus of the deformations and inner tensions generated by a welding process of metal parts suitable for composing a metal structure.

Currently, the choice of welding type, welding parameter and welding sequence of the parts of a complex metal structure are left to the expertise and experience of the welder.

As is known, during a welding process a structure undergoes deformations and residual inner tensions due to the tensions generated by the cooling of the welding beads.

Sometimes even the most expert welder is unable to accurately forecast the final effect of such deformations and inner tensions and is forced to proceed by trial and error or may find himself, at the end of the job with a piece not falling within the permitted tolerance range and which therefore has to be subjected to further adjustments.

The purpose of the present invention is to propose a simulation method and apparatus which permits a user not highly qualified in the welding field, to overcome the drawbacks mentioned above.

In particular, the present invention sets out to provide an instrument able to forecast the deformations and the state of the residual inner tensions which a metal structure undergoes during the welding process, thereby permitting the user to choose the most correct welding type, parameters and sequence for a determined structure to be welded.

Such purpose is achieved by a simulation method according to claim 1, with a simulation apparatus according to claim 18, and with a computer program product according to claim 19. The dependent claims describe preferred or advantageous embodiments of the simulation method.

The characteristics and advantages of the simulation method and apparatus according to the invention will, in any case, be evident from the description given below of its preferred embodiments, made by way of non-limiting examples with reference to the appended drawings, wherein:

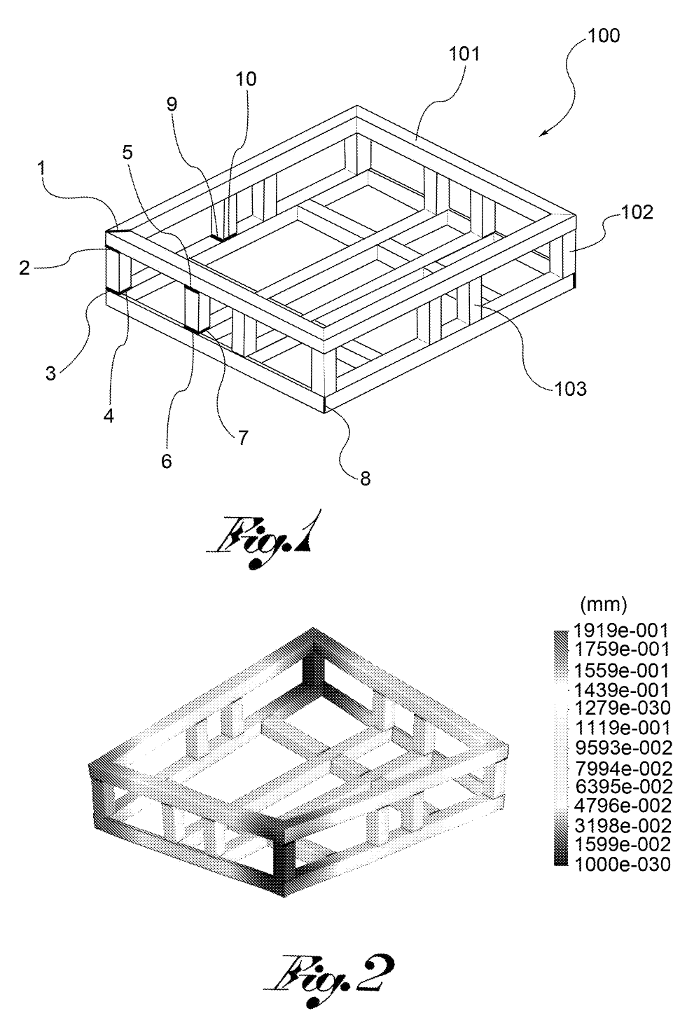

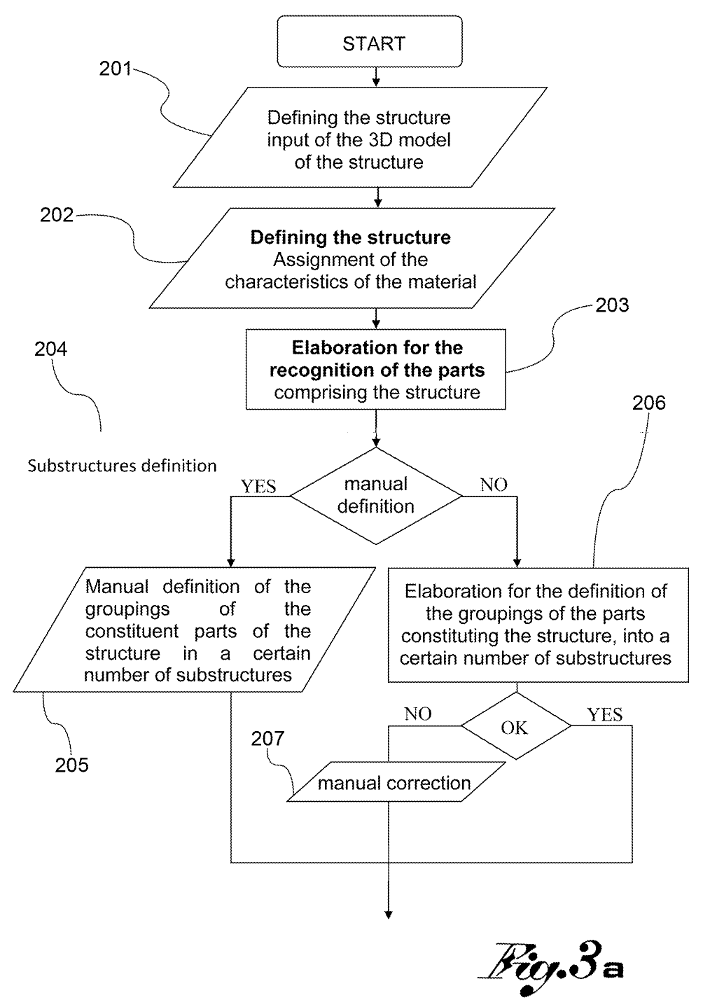

FIG. 1 shows an example of a structure to be welded, in which some welding areas are highlighted;

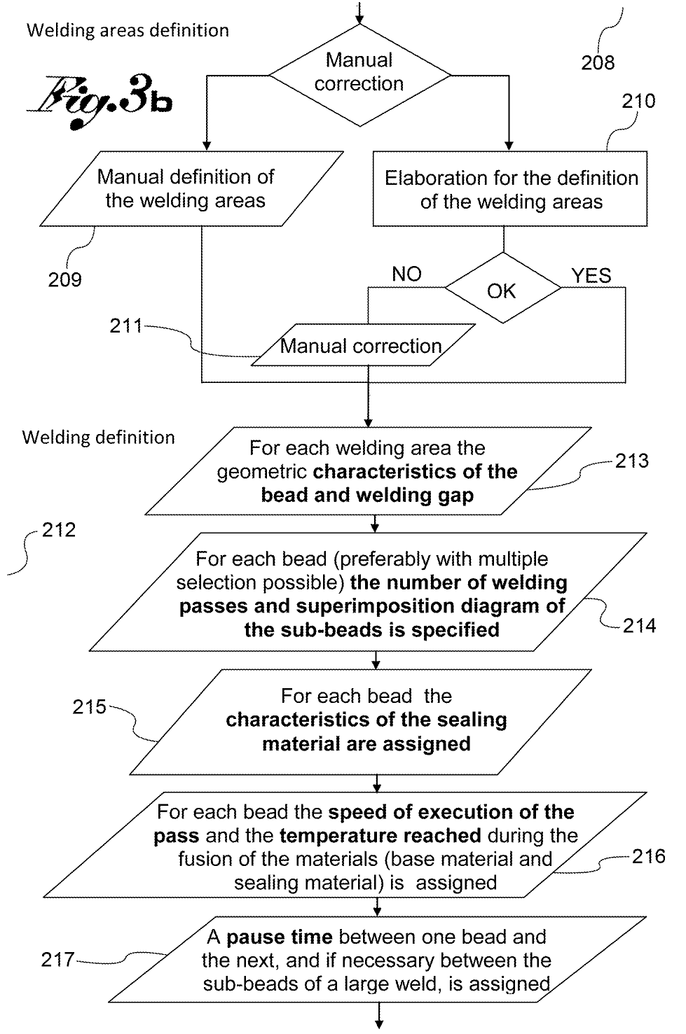

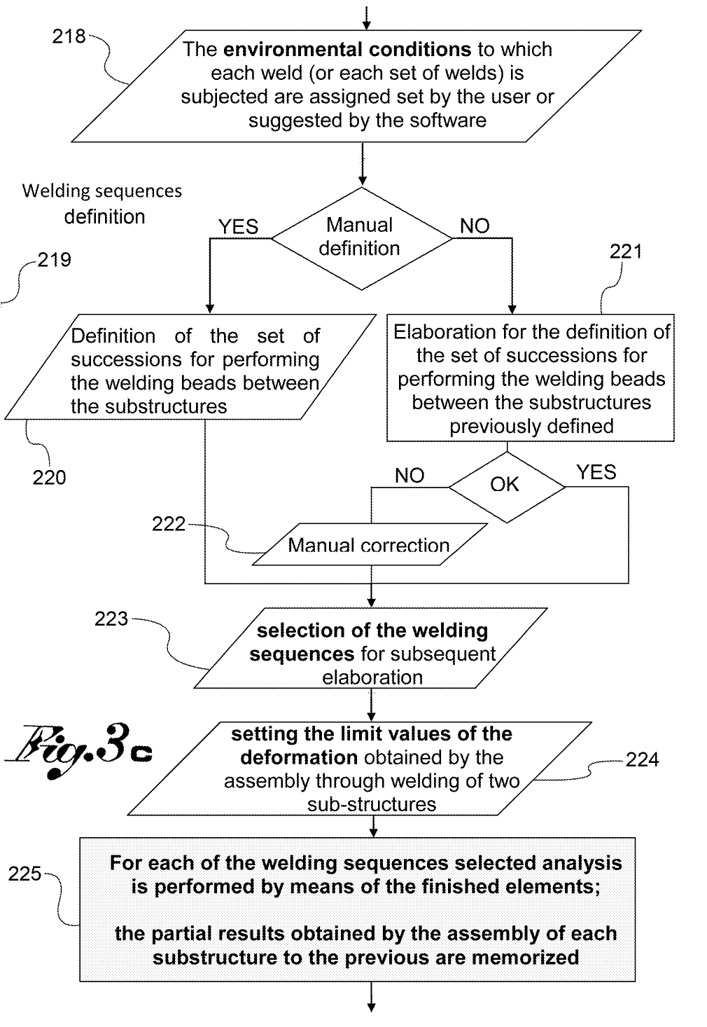

FIG. 2 is an example of a representation of the deformations and inner tensions undergone by the structure during welding; and

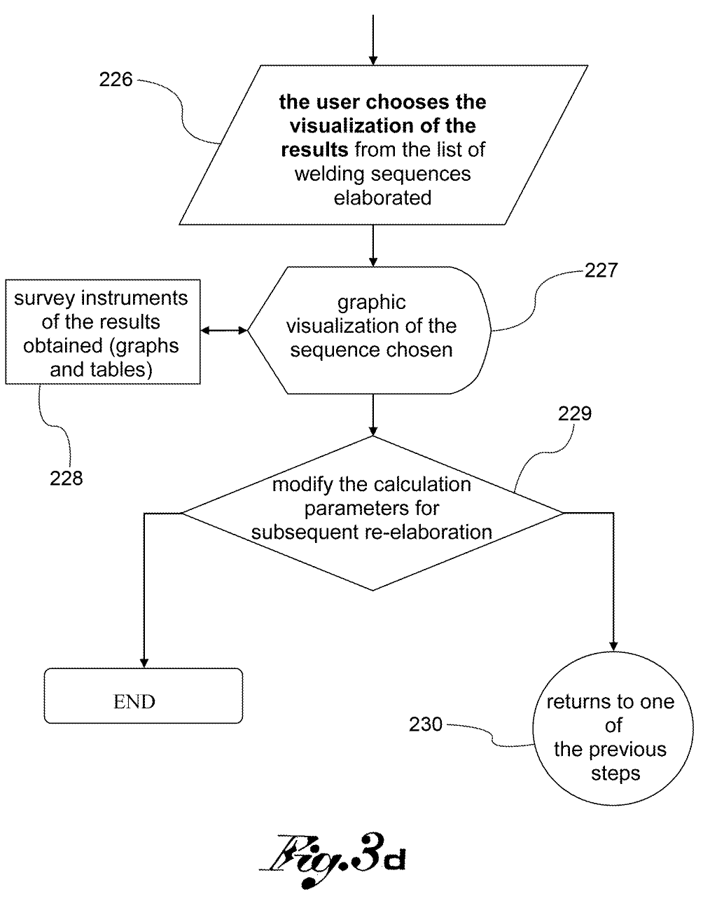

FIG. 3 is a flow diagram (broken into FIGS. 3a, 3b, 3c, and 3d which connect together) which shows the steps of the simulation method according to the invention.

The simulation method according to the invention uses a computerised simulation programme, such as a programme which implements a method of the finite elements, based on an analysis of the finite elements. Such simulation programme is used here to simulate the deformations and tensions generated by the welding of metal parts suitable for comprising a metal structure, such as the stand 100 shown in FIG. 1. This programme or any of the programs of the present invention can be stored or present on a non-transitory computer readable recording medium. Any of the methods (or one or steps thereof or functions) of the present invention can be performed using a computer or processor.

The simulation programme according to the invention envisages providing the simulation programme with a series of information relative to the structure to be welded and to the welding process to be used.

In particular, in one step of the method, the simulation programme is provided with information relative to the geometric characteristics and information relative to the characteristics of the material to be welded.

A second step of the method envisages providing the simulation programme or obtaining from the simulation programme information relative to the welding areas.

A third step of the method envisages providing the simulation programme with information relative to the welding characteristics.

A fourth step of the method envisages providing the simulation programme or obtaining from the simulation programme information relative to at least one welding sequence.

On the basis of the information obtained, for each welding sequence the simulation programme performs a simulation of the deformations and inner tensions generated by a welding process.

After performing the elaboration, the simulation programme visualises the result of the simulation. In the case of various sequences of welding imposed by the user or proposed by the simulation programme, the simulation programme visualises a similar number of results of the simulation so that the user can choose the one he deems most appropriate.

Preferably, the information relative to the geometric characteristics comprises the three-dimensional model of the structure.

Preferably, the information relative to the characteristics of the material to be welded comprises at least the following data: the unit tensile breaking strength, the unit yielding value, Young modulus, Poisson modulus, coefficient of thermic transmission, coefficient of thermic dilation.

In one form of implementation of the method according to the invention, the structure to be welded is dismantled into a plurality of parts or components 101,102,103 . . . . In particular, the structure may be dismantled into a plurality of substructures which must be joined by means of welding beads or spots to form the complete structure. Each substructure may be composed of one or more parts or components already pre-assembled, which in this case are deemed free of deformations and tensions.

The welding areas between the substructures where the welding beads or spots must be performed are then specified.

The information relative to the welding characteristics comprises the welding type and welding data. For example type of welding is taken to mean MIG, TIG, electrode, arc, plasma, laser, electronic beam, resistance welding.

The information relative to the welding characteristics comprises the geometric characteristics (in other words the shape and dimensions) of the welding bead or spots and of the welding gap.

Preferably, the information relative to the welding characteristics also comprises the number of welding passes and, in the case of more than one pass, the diagram of superimposition of the sub-beads.

Preferably, the information relative to the welding characteristics comprises the characteristics of the sealing material, such as the diameter of the wire, the quality of the material etc. . . . .

Preferably, the information relative to the welding characteristics also comprises the pass speed and/or temperature reached during the fusion of the materials (the material of the structure and the sealing material).

Preferably, the information relative to the welding characteristics also comprises an indication of the amperage and/or voltage at which the welding is performed.

Preferably, the information relative to the welding characteristics also comprises an indication of the pause time between one bead and the next (or even between the sub-beads in the case of a large weld).

Preferably, the information relative to the welding characteristics also comprises an indication of the environmental conditions at which the welding is performed.

Preferably, the information relative to the welding characteristics also comprises an indication of the support method of the parts to be welded, for example if the substructures are pinned to each other or held in position by mean of pincers and clamps.

In indicating the welding sequences one or more sequences of performance of the welding are assigned, that is to say a set of successions for the performance of the beads or of the welding spots between the various sub-structures. Each succession defines an order of execution of the welding beads or spots.

In FIG. 1, the references 1-10 indicate both the respective welding beads and a possible welding sequence.

In a preferred embodiment, the user provides the simulation programme with information relative to at least one limit value of the deformation caused by the welding between two parts of the structure.

In one embodiment variation of the simulation method, only the result of welding simulations the deformations of which do not exceed said at least one limit value are visualised.

In one implementation variation of the simulation method, at least one of the information items supplied to the simulation programme is supplied by selecting from a plurality of information items proposed by the simulation programme. For example, the simulation programme suggests possible characteristics of the sealing material or possible welding sequences. The user may choose one of the information items proposed by the simulation programme, or modify the characteristics suggested by the programme.

In one advantageous implementation variation of the method, the information relative to the tolerances, that is the limit values of the deformations set by the user, is supplied before the information relative to the welding sequence. In this case, it may be advantageous for the user to select one or more welding sequences from one or more welding sequences proposed by the simulation programme after the elaboration and able to comply with the tolerances set. In other words, the simulation programme, starting from the data previously entered by the user, performs a calculation of the deformations caused by all the possible welding sequences and then proposes to the user only those welding sequences which have not exceeded the deformation limit values set by the user. As a result, the user find himself choosing from a restricted range of possible sequences and, especially if not expert, does not have to proceed with too many unsatisfactory attempts

Preferably, the simulation programme also memorises and represents, as well as the final result of the welding process, the partial results obtained by the assembly of each sub-structure to the previous. In other words, for each welding sequence the relative results are presented, which include a graphic representation and/or table of the deformations and residual inner tensions obtained for each of the partial results of each step of the welding sequence.

FIG. 2 shows an example of representation of the geometric deformations undergone by the stand structure in FIG. 1 at the end of the simulated welding process, by means of a graduated scale of colours. A similar representation may be made for the residual inner tensions. Observing the graphic representation and the data shown on the graduated scale, the user may assess whether the result is acceptable or if the welding sequence or other parameters need to be varied.

The invention also relates to an electronic apparatus for simulating the deformations and tensions generated by the welding of metal parts suitable for composing a metal structure. According to a general embodiment, the apparatus comprises hardware and software means able to implement the simulation method described above in all its variations.

The apparatus therefore comprises:
first input means, suitable for permitting a user to provide said simulation programme with information relative to the geometric characteristics and information relative to the characteristics of the material of the structure to be welded;
second input means, suitable for permitting a user to provide said simulation programme with information relative to the welding areas;
third input means, suitable for permitting a user to provide said simulation programme with information relative to the welding characteristics;
fourth input means, suitable for permitting a user to provide said simulation programme with information relative to at least one welding sequence;
memorisation means containing a simulation programme suitable for simulating the deformations and tensions generated by a welding process on the basis of information provided by the user;
visualisation means suitable for visualising the result of said simulation;

For example, said input means comprise a user interface of the simulation programme suitable for receiving the information provided by the user.

FIG. 3 is a flow diagram of the simulation method of the deformations and strains in an assembled metal structure according to a preferred embodiment,

In a first step 201 of defining the structure to be welded, the simulation programme is provided with the three-dimensional model of the structure.

In a second step 202, again of defining the characteristics of the structure to be welded, the characteristics of the material of the structure are assigned.

The simulation programme then performs an elaboration for the recognition of the parts comprising the structure and number thereof (step 203).

A definition procedure of the substructure 204, which may be manual or automatic, is then performed.

If such definition procedure of the substructure is performed manually, a definition of the groupings of the parts constituting the structure into a certain number of substructures is provided to the simulation programme (step 205). If the definition procedure of the substructures is performed automatically by the simulation programme, on the basis of the information relative to the geometric characteristics and/or of the materials of the structure previously acquired, the programme performs an elaboration for the definition of the groupings of the parts constituting the structure, into a certain number of substructures (step 206) If such automatic definition is not satisfactory to the operator, the latter performs a manual correction (step 207).

A definition procedure of the welding areas 208, which may be manual or automatic, is then performed.

If such definition procedure of the welding areas is performed manually, a definition of the welding areas is provided to the simulation programme (step 209). If the definition procedure of the welding areas is performed automatically by the simulation programme, on the basis of the information previously acquired, the programme performs an elaboration for the definition of the welding areas (step 210). If such automatic definition is not satisfactory to the operator, the latter performs a manual correction (step 211).

A definition procedure of the welds 212 is then performed. Such procedure comprises the following steps:
for each welding area the geometric characteristics of the bead and welding gap, for example the shape and dimensions, are assigned (step 213);
for each bead (preferably with multiple selection possible) the number of welding passes and superimposition diagram of the sub-beads is specified; each bead may be performed with one pass only or several passes, in which case the sub-beads are performed (step 214);
for each bead the characteristics of the sealing material such as the diameter of the wire, quality of the material (suggested by the software and corrected if necessary by the user) are assigned (step 215);
for each bead the speed of execution of the pass and the temperature reached during the fusion of the materials (base material and sealing material) is assigned (step 216);
a pause time between one bead and the next, and if necessary between the sub-beads of a large weld, is assigned (step 217);
the environmental conditions to which each weld (or each set of welds) is subjected are assigned set by the user or suggested by the software (step 218).

A definition procedure of the sequence of welds 219, which may be manual or automatic, is then performed.

If such definition procedure of the weld sequence is performed manually, a definition of the set of successions for performing the welding beads between the substructures previously defined is provided to the simulation programme (step 220). If the definition procedure of the weld sequence is performed automatically by the simulation programme, the programme performs an elaboration for the definition of the set of successions for performing the welding beads between the substructures previously defined (step 221). If such automatic definition is not satisfactory to the operator, the latter performs a manual correction (step 222).

A selection of the welding sequences for subsequent elaboration is then made (step 223). In addition, the limit values of the deformation obtained by the assembly through welding of two sub-structures (step 224) are set.

For each of the welding sequences selected analysis is performed by means of the finished elements, and the partial results obtained by the assembly of each substructure to the previous are memorised (step 225).

The user then chooses the visualisation of the results from the list of welding sequences elaborated (step 226). The list may be ordered according to different criteria, for example on the basis of the maximum deformation or the maximum residual tension.

The simulation programme then performs a graphic visualisation of the sequence chosen (step 227), which can be supplemented with survey instruments of the results obtained (graphs and tables) (step 228).

The operator can then proceed to modify the calculation parameters for subsequent re-elaboration (step 229); in this case the programme returns to one of the previous steps (step 230).

Thanks to the simulation method and apparatus described, the user is able to assess the welding method beforehand so as to achieve acceptable deformations on the structure to be assembled.

Consequently, a person deciding which welding technology to use, in particular the weld type and sequence, may avail of an instrument able to forecast the final effect of the welding process on the structure without having to proceed by trial and error or worse, finding himself at the end of the job with a piece which does not fall within the tolerance range provided for and which must therefore be subjected to adjustments.

The user, simulating different welding processes, if necessary guided by the simulation programme, can then choose the best process for obtaining the desired piece.

A person skilled in the art may make modifications and variations to the simulation method and apparatus according to the invention, replacing elements with others functionally equivalent so as to satisfy contingent requirements while remaining within the sphere of protection of the following claims. Each of the characteristics described as belonging to a possible embodiment may be realised independently of the other embodiments described.

1. Method of simulation using a simulation programme to calculate the deformations and tensions generated by the welding of metal parts suitable for composing a metal structure, comprising the steps of:
a) providing the simulation programme with information relative to the geometric characteristics and information relative to the characteristics of the material to be welded;
b) defining the welding areas;
c) providing the simulation programme with information relative to the welding characteristics;
d) defining at least one welding sequence;
e) performing, for each welding sequence and depending on the information obtained in steps a)-c), a simulation of the deformations and inner tensions generated by a welding process by means of said computerised simulation programme;
f) visualising the result of said simulation.

2. Method according to claim 1, wherein the information relative to the geometric characteristics comprises the three-dimensional model of the structure, and wherein the information relative to the characteristics of the material of the structure to be welded comprises: the unit tensile breaking strength, the unit yielding value, Young modulus, Poisson modulus, coefficient of thermic transmission, coefficient of thermic dilation.

3. Method according to claim 1, wherein the step b) comprises:
sub-dividing the structure into two or more substructures to be welded;
defining the welding areas between the substructures.

4. Method according to claim 1, wherein the information relative to the welding characteristics comprises the welding type and welding data.

5. Method according to claim 1, wherein the information relative to the welding characteristics comprises the geometric characteristics of the welding bead or spots.

6. Method according to claim 1, the information relative to the welding characteristics comprises the geometric characteristics of the welding gap.

7. Method according to claim 1, wherein the information relative to the welding characteristics comprises the number of welding passes and, in the case of more than one pass, the diagram of superimposition of the sub-beads.

8. Method according to claim 1, wherein the information relative to the welding characteristics comprises the characteristics of the sealing material.

9. Method according to claim 1, wherein the information relative to the welding characteristics comprises the pass speed.

10. Method according to claim 1, wherein the information relative to the welding characteristics also comprises an indication of the environmental conditions at which the welding is performed.

11. Method according to claim 1, wherein the information relative to the welding characteristics comprises at least one indication of the support method of the parts to be welded.

12. Method according to claim 1, further comprising the step of:
providing the simulation programme with information relative to at least one limit value of the deformation caused by the welding between two parts of the structure.

13. Method according to claim 1, wherein in step f) only the result of welding simulations the deformations of which do not exceed said limit value are visualised.

14. Method according to claim 1, wherein at least one of the information items obtained in steps a)-d) is supplied selecting from a plurality of information items proposed by the simulation programme.

15. Method according to claim 12, wherein said information relative to at least one limit value of the deformation is supplied before the information relative to the welding sequence, and wherein said information relative to the welding sequence is selected from one or more welding sequences proposed by the simulation programme and able to comply with the deformation requisite imposed by said at least one limit value.

16. Method according to claim 1, wherein the step of visualising the result of the simulation comprises a visualisation of the partial results relative to the single welds of the welding sequence.

17. Method according to claim 1, wherein the simulation programme is based on an analysis of the finite elements.

18. Electronic apparatus for simulating the deformations and tensions generated by the welding of metal parts suitable for composing a metal structure, comprising:
memorisation means containing a simulation programme suitable for implementing a simulation method of the deformations and tensions generated by a welding process according to any of the previous claims;
first input means, suitable for permitting a user to provide said simulation programme with information relative to the geometric characteristics and information relative to the characteristics of the material of the structure to be welded;
second input means, suitable for permitting a user to provide said simulation programme with information relative to the welding areas;
third input means, suitable for permitting a user to provide said simulation programme with information relative to the welding characteristics;
fourth input means, suitable for permitting a user to provide said simulation programme with information relative to at least one welding sequence;
visualisation means suitable for visualising the result of said simulation;

19. Electronic apparatus according to claim 18, wherein said simulation programme implements a method of the finite elements.

20. Computer program product directly loadable in the internal memory of a computer and comprising portions of software code suitable for implementing the simulation method according to claim 1 when the programme is run on a computer.
